(19) United States
(12) Patent Application Publication
(10) Pub. No.: US 2009/0049615 A1
(43) Pub. Date: Feb. 26, 2009

(54) Foam spring for pillows, cushions, mattresses or the like and method for manufacturing such a foam spring

(75) Inventor: Willy Poppe, Sint-Niklaas (BE)

Correspondence Address: K&L Gates LLP, 214 N. TRYON STREET, HEARST TOWER, 47TH FLOOR, CHARLOTTE, NC, 28202, US

(73) Assignee: IMHOLD, naamloze vennootschap, SINT-NIKLAAS (BE)

(21) Appl. No.: 11/894,450

(22) Filed: Aug. 21, 2007

(51) Int. Cl. B68G 5/02; B26D 1/12

(52) U.S. Cl. 5/655.7; 83/676

(57) ABSTRACT

A foam spring for use in pillows, cushions, mattresses or the like, the foam spring having a tubular resilient body made of foam with holes extending inwardly from an outside surface to an inside location, wherein the holes extend at a non-perpendicular angle relative to a line perpendicular to the outside surface of the spring at the position of the hole. The foam spring is manufactured by a method which comprises providing interrupted slits along lines extending in the longitudinal direction of a foam layer; cutting a transverse strip out of this foam layer; bending two opposite ends of the strip towards each other; and fixing the two opposite ends into a tubular shape to form the tubular resilient body, wherein the slits are made in a direction forming an angle with the direction perpendicular to the surface of the foamed layer.

### BACKGROUND OF THE INVENTION

1. Field of the Invention

The present invention concerns a foam spring in particular a foam spring with a tubular resilient body made of foam with holes extending inwards from the outside and which can be applied in the core of pillows, mattresses, armchair cushions or the like.

The invention also concerns a method of manufacturing such a foam spring.

2. Discussion of the Related Art

Such foam springs are known for example from US Published Patent Application No. 2005172468 and European Patent Document EP 0.872.198, disclosing a foam spring made out of a foam layer strip of for example latex or polyurethane foam, provided with slits, whereby the strip is bent and two opposite ends of the strip are glued together to form a hollow tubular body with diamond shaped holes formed by stretching the slits in a lateral direction due to the bending of the strip.

With the known foam springs the slits in the foam layer extend in a direction perpendicular to the foam layer strip, resulting in a foam spring with holes extending in a direction perpendicular to the outside surface of the spring at the position of the hole.

Said slits are made for example using straight knives with a cutting motion perpendicular to the surface of the strip.

Such springs can have a cylindrical shape with radially extending holes or rather a bi-conical shape as disclosed in US Published Patent Application No. 2005172468 or a barrel shape as disclosed in European Patent Document EP 0.872.198.

### SUMMARY OF THE INVENTION

It is an object of the present invention to provide a foam spring with improved properties for use in pillows, cushions, mattresses or the like.

To this end, the invention concerns a foam spring that is provided with a tubular resilient body made of foam with holes extending inwardly from the outside to the inside, wherein the holes extend in a direction forming an angle with the direction perpendicular to the outside surface of the spring at the position of the hole.

Such a foam spring has a different resiliency than known foam springs with holes extending in the radial direction or in a direction perpendicular to the outside surface of the spring at the position of the hole.

When used in pillows, mattresses or the like, the user experiences a great feeling of comfort.

These foam springs according to the invention can of course be combined with other types of springs in order to create different comfort zones with different softness in a pillow, mattress or the like.

In this manner, the pillow, mattress or the like can be personalised to the user's body shape and preferences.

Depending on the angle formed by the direction in which the holes extend with respect to the direction perpendicular to the outer surface of the spring, the spring can be made softer or firmer depending on the users needs. Also the spring gives a different feel of comfort to the user of the pillow, mattress or the like, whether the holes in the spring are oriented in a downward or upward or horizontal direction.

The invention also concerns a method for manufacturing such a foam spring, which method is mainly comprised of providing interrupted slits along lines extending in the longitudinal direction of a foam layer; cutting a transverse strip out of this foam layer; bending two opposite ends of the strip towards each other; and fixing both these opposing ends in order to form a tubular resilient body. The slits are made in a direction forming an angle with the direction perpendicular to the surface of the foamed layer.

Preferably the slits are formed by a cutting device with at least one cutting element that is provided on a rotatable shaft with a drive mechanism, whereby the shaft extends in a direction transverse to the longitudinal direction of the foam layer.

Such a rotating cutting device is very simple and allows in the use of the method in a continuous process for cutting slits in a continuous foam layer. It is advantageous to use a cutting disk with a plurality of cutting blades on its circumference with a length corresponding to the longitudinal length of the slits.

The form and dimensions of the disk and of the cutting blades can be adapted in order to obtain that the slits are automatically cut forming an angle with the direction perpendicular to the foam layer.

The angle of the slits can be varied depending on the diameter of the disk, the thickness of the foam layer and the form of the cutting blades.

### BRIEF DESCRIPTION OF THE DRAWINGS

In order to better explain the characteristics of the invention, the following preferred embodiment of a foam spring and of a method according to the invention for manufacturing such a foam spring is described as an example only without being limiting in any way, with reference to the accompanying drawings, in which:

FIG. 1 represents a perspective view of a foam spring according to the invention;

FIG. 2 represents a foam layer with slits used for manufacturing a foam spring according to the invention;

FIG. 3 is a cross-section according to line II-II in FIG. 2;

FIG. 4 is an illustration of using a foam layer strip for making a foam spring according to the invention;

FIG. 5 illustrates the method of making a foam layer as represented in the FIGS. 2 and 3;

FIG. 6 represents a view following the direction indicated by F6 in FIG. 5;

FIG. 7 represents on a larger scale the part which in FIG. 5 is indicated by F7;

FIG. 8 is an illustration similar to that of FIG. 7 but for another embodiment;

FIG. 9 represents a cross-section according to line IX-IX in FIG. 6, but for a different embodiment.

### DESCRIPTION OF THE PREFERRED EMBODIMENT

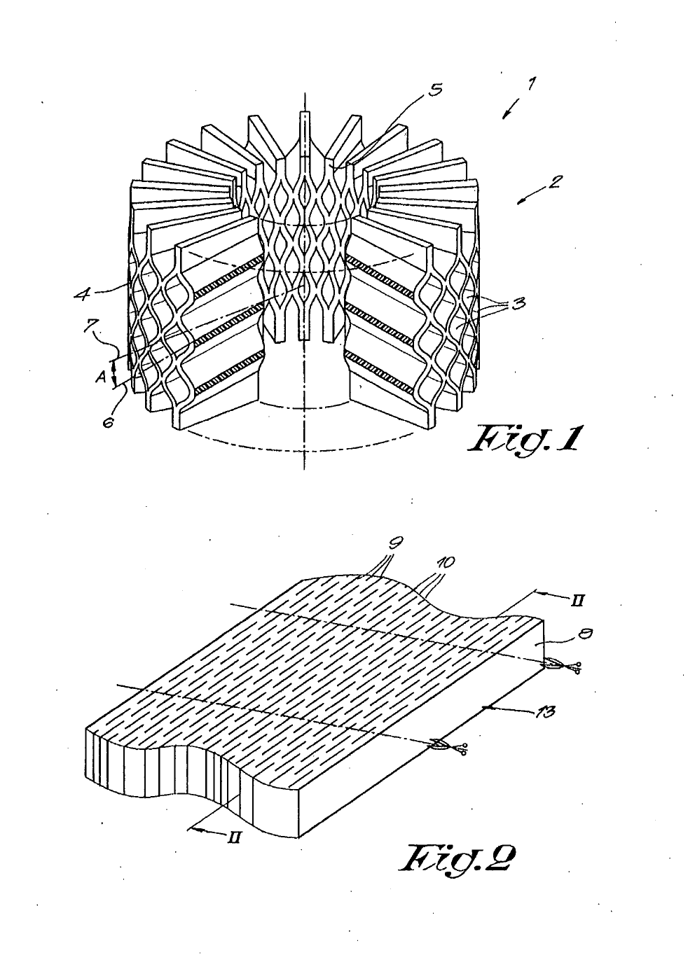

The spring represented in FIG. 1 is a foam spring 1 for use in pillows, cushions, mattresses or the like, and is comprised of a tubular resilient body 2 made of foam with holes 3 extending inwardly from the outside surface 4 to the inside surface 5 of the spring 1, wherein the holes 3 extend in a direction 6 forming an angle A relative to a geometrical radius 7 extending from the longitudinal axis X-X′ of the tubular body 2 perpendicularly to the outer or inner surface of the spring at the position of the hole 3. The angle A is preferably located in a radial plane extending through and including the longitudinal axis X-X′ of the tubular body 2.

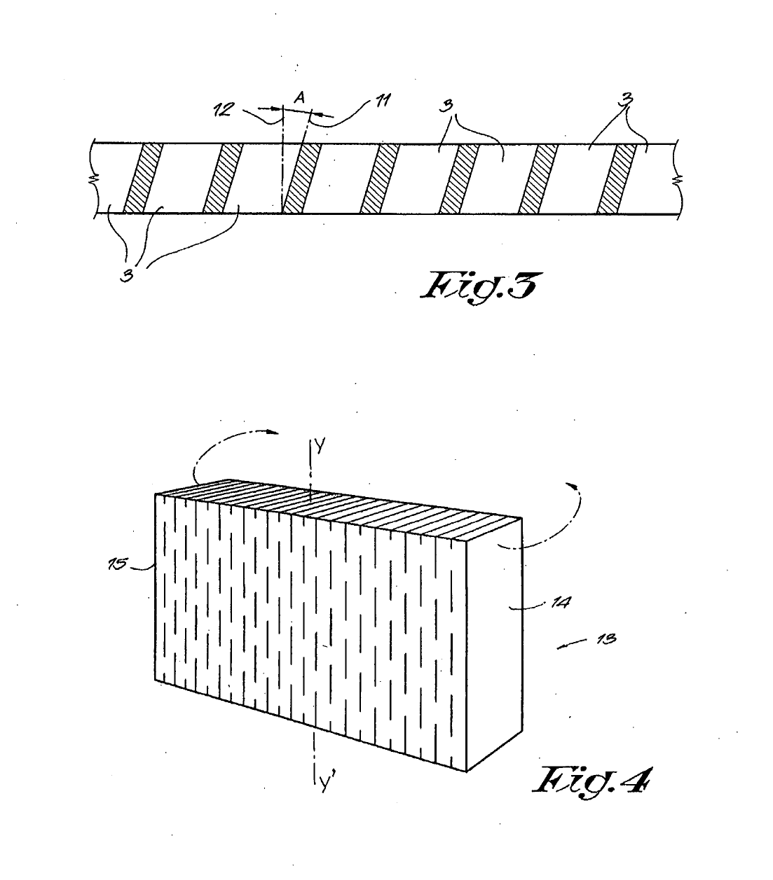

The foam spring 1 is made out of a foam layer 8 as represented in FIG. 2, with a series of slits 9 extending in the longitudinal direction Y-Y′.

The slits 9 in the foam layer 8 are cut along a plurality of interrupted parallel lines at a distance from each other.

The slits 9 are advantageously positioned according to a staggered pattern, whereby the slits 9 along adjacent lines 10 are offset in their longitudinal direction Y-Y′, for example over a distance equal to half the longitudinal length of the slits 9.

In particular, the direction 11 of the slits 9 form an angle A with the direction 12 perpendicular to the surface of layer 8, whereby the slits 9 preferably extend in a plane perpendicular to the surface of the layer 8.

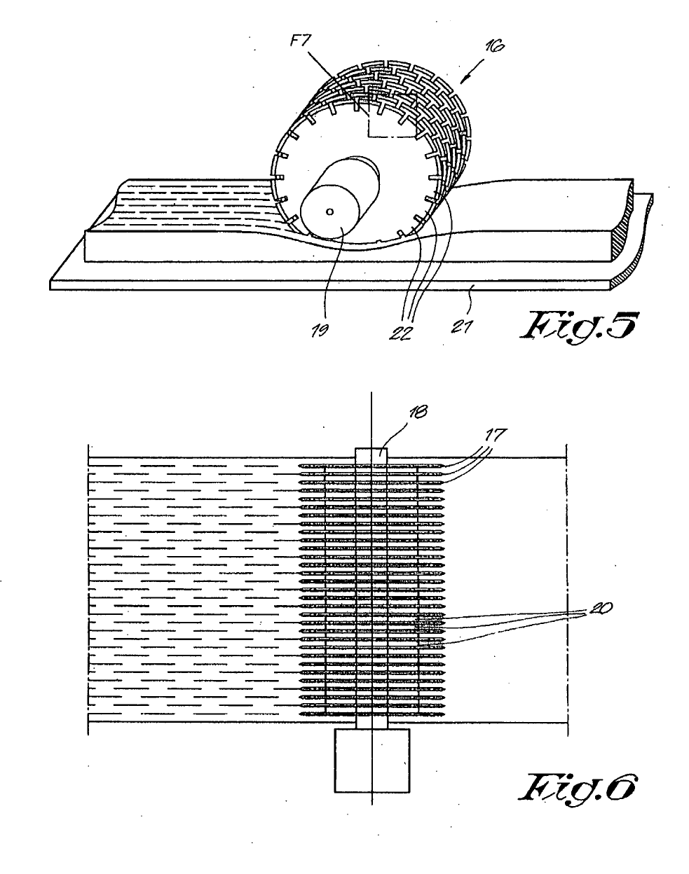

As represented by the dotted lines in FIG. 2, the foam layer 8 is transversely cut in strips 13, each strip presenting two opposite ends 14 and 15 extending in the longitudinal direction Y-Y′ of the slits 9, which opposite ends 14 and 15 are bent towards each other, as represented with the dotted arrows in FIG. 4, and are fixed together, by gluing or other technique, to form said hollow tubular body 2 of the spring 1 with holes 3 that are diamond like shaped by stretching the slits 9 in a transversal direction Z-Z′ due to the bending of the strip 13.

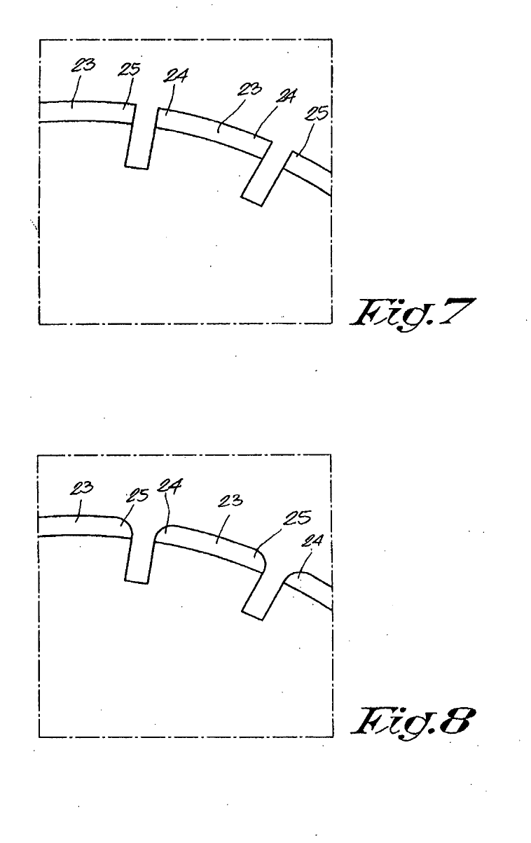

FIGS. 5 and 6 illustrate a method of providing slits 9 in the foam layer 8 as represented in the FIGS. 2 and 3, in particular slits 9 that are cut in the plane perpendicular to the foam layer 8 and extending in a direction 11 forming an angle A with the direction 12 perpendicular to the surface of the foam layer 8.

In the example shown, the slits 9 are formed by a cutting device 16 in the form of a plurality of cutting disks 17 arranged on a rotatable shaft 18 with a drive mechanism 19 in the form of a motor or the like.

The disks 17 are separated from each other by spacers 20.

The cutting device 16 is provided above a transport table 21 forming a support on which the foam layer 8 to be provided with slits can move in the longitudinal direction.

The shaft 18 extends in a direction transversal to the longitudinal direction of the table 21 and of the foam layer 8.

Each of the disks 17 is provided with a plurality of cutting blades 22 with a length corresponding to the longitudinal length of the slits 9 to be cut.

The cutting blades 22 are provided with a cutting edge 23 which, in the case of the Figures, is formed by the circumference of the disk 17.

The cutting blades 22 of the two adjacent cutting disks 17 are rationally shifted with respect to each other, for example over an angle corresponding to half the length of the blades 22.

When the cutting device 16 is activated by the driving mechanism 19, the cutting blades 22 cut into the foam layer 8 to form the rows or lines 10 of slits 9.

In order to get a clean cut, it is advantageous to provide longitudinal slits (not shown) in the table 21 in which the cutting blades 22 move during the rotation of the cutting device 16, these slits having a width mainly corresponding to the thickness of the cutting blades 22.

The diameter of the disks 17 and the thickness of the foam layer will determine the desired angle A of the slits 9 in the foam layer 8.

The smaller the diameter of the disks 17, the larger the angle A.

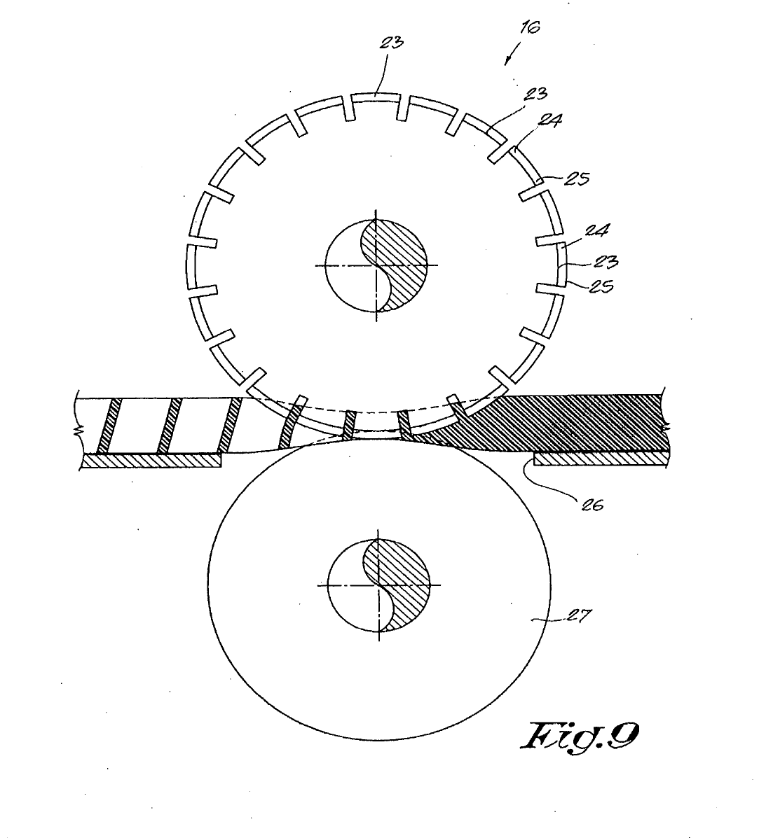

Although the tips 24 and 25 of the cutting edges 23 will normally be angled as shown in FIG. 7, the angle A of the holes can for instance be influenced by chamfering, filleting or rounding the tips 24 and/or 25 of the cutting blades as shown in FIG. 8, whereby filleting or chamfering will reduce the angle A because of the fact that the time that the cutting blades begin to cut in the foam layer 8 is retarded.

Another possibility is that the cutting edges 23 of the cutting blades 22 are not formed by the circumference of the disks 17, but that these cutting edges 23 are straight and slanting with respect to the radial direction.

By altering the angle A, it is clear that also the features of the foam spring will be altered, allowing this way to manufacture springs with different features, simply by changing the cutting device 16, in particular by changing the disks of the cutting device.

It is clear that the cutting device does not necessarily have to be assembled by using disks, but that the cutting device can also be formed by a drum with cutting blades, or in a simplified embodiment by only one cutting blade disposed on a rotating shaft.

Instead of providing slits in the table 20 in order to get clean cuts, an alternative method consists in proving a table 20 which is interrupted by an opening 26 underneath the cutting device, and providing a counter role 27 co-operating with the cutting device 16, the foam layer 8 being introduced between the counter role 27 and the cutting device 16.

The present invention is by no means limited to the above-described embodiments given as an example and represented in the accompanying drawings; on the contrary, such a foam spring and method for manufacturing such a spring can vary while still remaining within the scope of the invention.

What is claimed is:

1. A foam spring for use in pillows, cushions, mattresses or the like, the foam spring having a tubular resilient body made of foam with holes extending inwardly from an outside surface to an inside location, wherein the holes extend at an angle relative to a geometrical radius of the tubular resilient body extending from the longitudinal axis thereof perpendicularly to the outside surface of the spring at the position of the hole.

2. The foam spring according to claim 1, wherein said angle is located in a plane comprising the longitudinal ax is of the tubular body.

3. The foam spring according to claim 1, wherein the spring comprises a foam layer strip with a series of slits extending in one direction and two opposite ends extending in the direction of the slits, the opposite ends of the strip being bent into proximity to each other and glued together to form said hollow tubular body and to form said holes in a diamond shape by stretching the slits in a transverse direction due to the bending of the strip.

4. The foam spring according to claim 3, wherein the slits extend along a plurality of interrupted parallel lines.

5. The foam spring according to claim 4, wherein the slits are positioned according to a staggered pattern, wherein the slits along adjacent lines are offset in their longitudinal direction.

6. The foam spring according to claim 3, wherein the slits in the foam strip form an angle with the direction perpendicular to the surface of the strip.

7. The foam strip according to claim 6, wherein the slits extend in a plane perpendicular to the surface of the strip.

8. A method for manufacturing a foam spring with a tubular, resilient body for use in pillows, mattresses or the like, which method comprises providing interrupted slits along lines extending in the longitudinal direction of a foam layer; cutting a transverse strip out of this foam layer; bending two opposite ends of the strip towards each other; and fixing the two opposite ends into a tubular shape to form the tubular resilient body, wherein the slits are made in a direction forming an angle relative to a line perpendicular to the surface of the foam layer whereby the slits form holes in the tubular resilient body which extend at an angle relative to a geometrical radius of the tubular resilient body extending from the longitudinal axis thereof perpendicularly to the outside surface of the tubular resilient body.

9. The method according to claim 7, wherein the slits extend in a plane perpendicular to the surface of foam layer.

10. The method according to claim 9, wherein the slits are formed by a cutting device with at least one cutting element that is provided on a rotatable shaft with a drive mechanism, whereby the shaft extends in a direction transverse to the longitudinal direction of the surface of the foam layer.

11. The method according to claim 10, wherein the cutting device is a cutting disk with a plurality of cutting blades with a length corresponding to the longitudinal length of the slits.

12. The method according to claim 12, wherein the cutting blades are provided with cutting edges formed by the circumference of the disk.

13. The method according to claim 11, wherein the cutting edge of the cutting blades is rounded or chamfered at least at one of its tips.

14. The method according to claim 10, wherein a plurality of slits are cut simultaneously by the use of a cutting device comprising a plurality of cutting disks assembled on the same shaft and separated by spacers.

15. The method according to claim 15, wherein a cutting device is used wherein the cutting blades of the two adjacent cutting disks are rationally shifted over half a length of the blades.

16. The method according to claim 11, wherein the cutting disk co-operates with a counter role, the foam layer being introduced between the cutting disk and the counter role for cutting the slits.
